(19) United States
(12) Patent Application Publication
(10) Pub. No.: US 2024/0333027 A1
(43) Pub. Date: Oct. 3, 2024

(54) Information Processing Method, Information Processing Device, and Non-Transitory Computer-Readable Storage Medium

(71) Applicant: Tokyo Electric Power Company Holdings, Incorporated, Tokyo (JP)

(72) Inventors: Takafumi Anegawa, Tokyo (JP); Noboru Araki, Tokyo (JP); Satoru Yoshida, Tokyo (JP); Tomoya Imazu, Tokyo (JP)

(21) Appl. No.: 18/575,928

(22) PCT Filed: Jul. 5, 2021
(86) PCT No.: PCT/JP2021/025330

§ 371 Date: Jan. 2, 2024

(51) Int. Cl. H02J 13/00; G06Q 40/04; G06Q 50/06

(52) U.S. Cl. CPC H02J 13/00034; G06Q 40/04; G06Q 50/06

(57) ABSTRACT

An information processing method that is executed by a computer includes a process of: acquiring information indicating a connection status of an electric vehicle to a charger/discharger managed by an aggregator; specifying a degree of contribution to the aggregator by the electric vehicle according to the connection status; and giving a benefit in association with a user of the electric vehicle according to the specified degree of contribution. Preferably, the degree of contribution is specified on the basis of a parallel waiting time of the electric vehicle for the charger/discharger, the number of parallel waiting operations, the number of times the electric vehicle is charged and discharged through the charger/discharger, a charge and discharge time, charge and discharge power, or an amount of charge and discharge power.

### CROSS-REFERENCE TO RELATED APPLICATIONS

This application is the national phase under 35 U. S. C. § 371 of PCT International Application No. PCT/JP2021/025330 which has an International filing date of Jul. 5, 2021 and designated the United States of America.

### FIELD

The present invention relates to an information processing method, an information processing device, and a non-transitory computer-readable storage medium.

### BACKGROUND

A method has been proposed which uses an electric vehicle as a distributed power source in order to adjust supply and demand in a power transmission and distribution network.

For example, International Publication No. 2019/130930 discloses a vehicle management system that, in a case where a user parks an electric vehicle in a parking lot with a charge station and supplies power to a power system or charges the electric vehicle through the charge station, sets reward points that can be used for a parking fee and the like for the user according to charge and discharge transaction information.

### SUMMARY

However, the present invention according to International Publication No. 2019/130930 just sets reward points for the user who has parked the vehicle in a specific parking lot, but does not give any benefit to the user in a case where the vehicle is charged or discharged, for example, at any location such as home or workplace.

An object of an aspect of the present disclosure is to provide an information processing method and the like that can suitably utilize an electric vehicle as a distributed power source.

According to an aspect, there is provided an information processing method executed by a computer. The information processing method includes a process of: acquiring information indicating a connection status of an electric vehicle to a charger/discharger managed by an aggregator; specifying a degree of contribution to the aggregator by the electric vehicle according to the connection status, and giving a benefit in association with a user of the electric vehicle according to the specified degree of contribution.

According to the aspect, it is possible to suitably utilize an electric vehicle as a distributed power source.

The above and further objects and features will more fully be apparent from the following detailed description with accompanying drawings.

### BRIEF DESCRIPTION OF THE DRAWINGS

FIG. 1 is a diagram illustrating an example of a configuration of a charge and discharge management system.

FIG. 2 is a block diagram illustrating an example of a configuration of a server.

FIG. 3 is a block diagram illustrating an example of a configuration of a terminal.

FIG. 4 is a diagram illustrating an example of a record layout of a user DB, an adjustment schedule DB, a charger/discharger DB, and a public charger DB.

FIG. 5 is a diagram illustrating an outline of Embodiment 1.

FIG. 6 is a diagram illustrating an example of a display screen of a terminal.

FIG. 7 is a flowchart illustrating a procedure of a point giving process.

FIG. 8 is a flowchart illustrating a procedure of a point usage process.

FIG. 9 is a diagram illustrating an outline of Embodiment 2.

FIG. 10 is a flowchart illustrating a procedure of a connection trend prediction process.

### DETAILED DESCRIPTION

Hereinafter, the present disclosure will be described in detail with reference to the drawings illustrating embodiments of the present invention.

### Embodiment 1

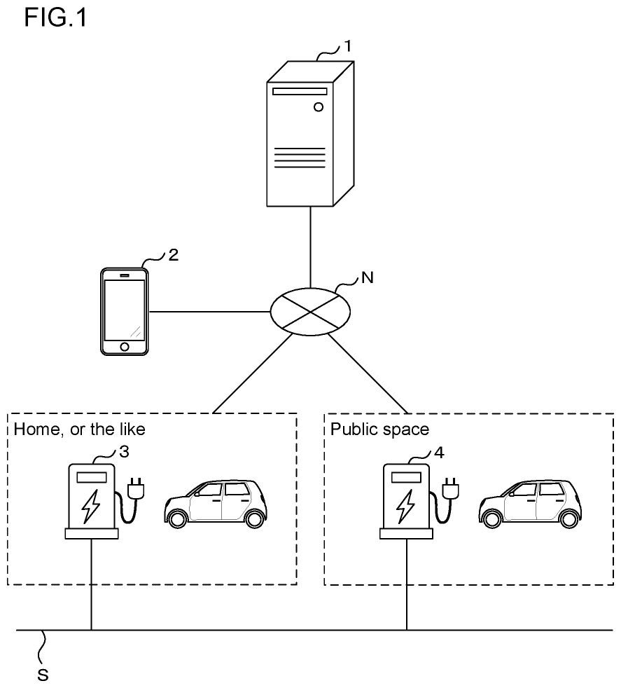

FIG. 1 is a diagram illustrating an example of a configuration of a charge and discharge management system. In this embodiment, the charge and discharge management system will be described which, in a case where an electric vehicle is connected to a charger/discharger 3 managed by an aggregator that adjusts power supply and demand, gives a benefit to a user of the electric vehicle according to the degree of contribution to the aggregator by the connection of the electric vehicle.

Before the description of the charge and discharge management system according to this embodiment (hereinafter, referred to as “this system”), an operation form of this system will be described. An operator of this system serves as both a resource aggregator (RA) and an e-mobility service provider (eMSP), provides a power supply capability and an adjustment capability to a general power transmission and distribution business operator or the like, and is in charge of authentication, billing, and the like at the time of charging at a charger installed in a public space.

The resource aggregator is a business operator that collects a large number of small-scale energy resources (power generation equipment, power storage equipment, and/or load equipment) and uses them as a power supply capacity and a supply and demand adjustment capacity equivalent to those of large-scale power sources. The resource aggregator aggregates the energy resources of a plurality of customers, performs integrated control of power supply and demand, and performs power sales transactions with a general power transmission and distribution business operator, a retailer, and the like.

In addition, the aggregator referred to in this specification is not limited to the resource aggregator that directly controls the energy resources of the customers, but may be an aggregation coordinator that aggregates a plurality of resource aggregators. That is, the aggregator may be any business operator that can directly or indirectly perform the integrated control of the energy resources of a plurality of customers.

The e-mobility service provider is a business operator that develops billing infrastructure for the chargers installed in the public space and the like and is in charge of user authentication, settlement of charging fees, and the like when the users use the chargers. The e-mobility service provider centrally manages payment information (credit card information and the like) of each user and performs user authentication (for example, ID authentication using an IC card), settlement after charging is completed, and the like in a case where the user performs charging using a charger of an affiliated business operator.

Hereinafter, this system will be described. This system includes an information processing device 1, a terminal 2, the charger/discharger 3, and a public charger 4. Each device is connected to a network N such as the Internet. In addition, the charger/discharger 3 and the public charger 4 are connected to a power transmission and distribution network S and exchange power with the power transmission and distribution network S. Further, in FIG. 1, one charger/discharger 3 and one public charger 4 are illustrated. However, the description will be made assuming that a plurality of chargers/dischargers 3 and a plurality of public chargers 4 are provided.

The information processing device 1 is an information processing device that can process various types of information and can transmit and receive information and is, for example, a server computer, a personal computer, or the like. In this embodiment, it is assumed that the information processing device 1 is a server computer. The information processing device 1 will be read as a server 1 below for brevity's sake.

The server 1 is a server computer of the operator of this system, specifies the degree of contribution of the user to the aggregator by the electric vehicle (for example, the degree of contribution to power supply and demand adjustment in the power transmission and distribution network S) according to the connection status of the electric vehicle to the charger/discharger 3 managed by the aggregator (operator), and gives a benefit to the user. Specifically, the server 1 gives points (credits) that can be used for the settlement of a charging fee at the public chargers 4 dispersively disposed in the public spaces, which will be described below. The giving of the benefit makes it possible for the aggregator to improve, for example, the connection rate of the electric vehicle to the charger/discharger 3 and makes it possible to reduce subscription fees for public charging services that are a burden on the users of the electric vehicles.

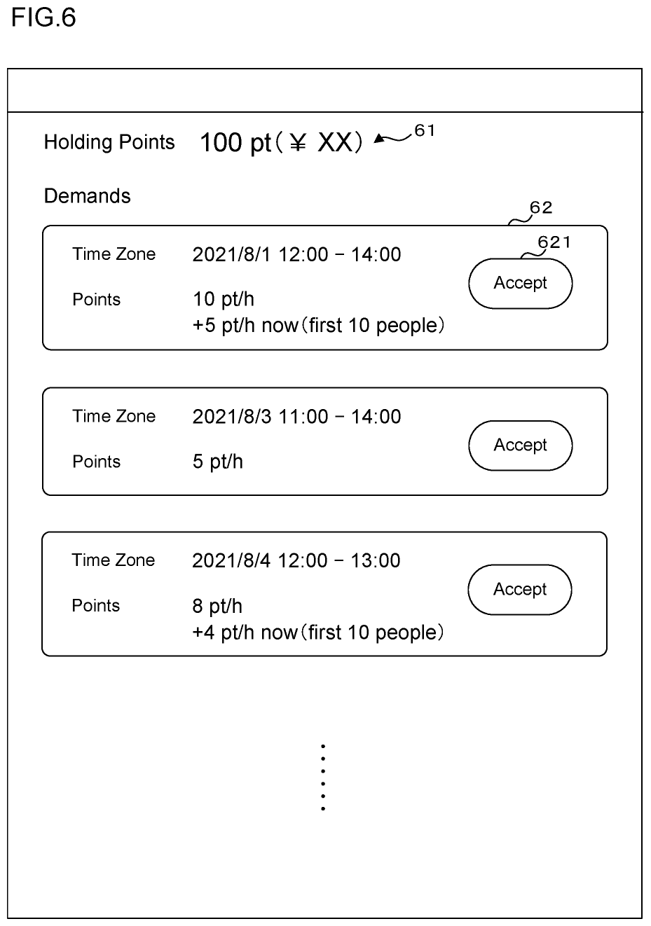

The terminal 2 is an information processing terminal used by a user who is a member of this system and is, for example, a smartphone, a tablet terminal, a personal computer, or the like. The server 1 delivers a request to connect the electric vehicle to the charger/discharger 3 to the terminal 2 in response to an adjustment request from the general power transmission and distribution business operator or the like, which will be described below. The server 1 gives points to the user according to the connection status of the electric vehicle in response to the connection request. For example, an application program for performing a process according to this embodiment is installed in the terminal 2 in advance, and the terminal 2 executes the application program to display the connection request delivered from the server 1 (see FIG. 6) such that the user connects the electric vehicle.

The charger/discharger 3 is an electric vehicle charger that is installed at each customer and that is managed by the aggregator. The charger/discharger 3 is installed, for example, at the home, workplace, or the like of the user, receives power from the power transmission and distribution network S to charge the electric vehicle, and performs discharging (power supply) from the electric vehicle to the power transmission and distribution network S. The charger/discharger 3 is connected to the server 1 such that it can communicate with the server 1 and can perform charging and discharging in response to commands (demand response) from the server 1. In addition, the charger/discharger 3 may be the user's property or may be a leased product lent to the user, which will be described below.

The public chargers 4 are chargers that are managed by a business operator affiliated with the operator of this system and that are dispersively disposed in the public spaces (for example, parking lots, commercial facilities, and the like). The public charger 4 is managed by an external charging point operator (CPO; a business operator that installs and maintains chargers) or an e-mobility service provider other than the operator. Further, an administrator of the public charger 4 and the operator of this system may be the same.

In addition, in this embodiment, the description is made assuming that the aggregator that gives points is the same as the e-mobility service provider that performs the settlement of the charging fee at the public charger 4 with the points. However, both the aggregator and the e-mobility service provider may be different business operators. For example, the server 1 may only perform the function (the management of the charger/discharger 3) of the aggregator, and another computer may perform the function (the settlement of the charging fees) of the e-mobility service provider. As described above, the two business operators are different from each other. Further, in this case, the server 1 gives and manages the points.

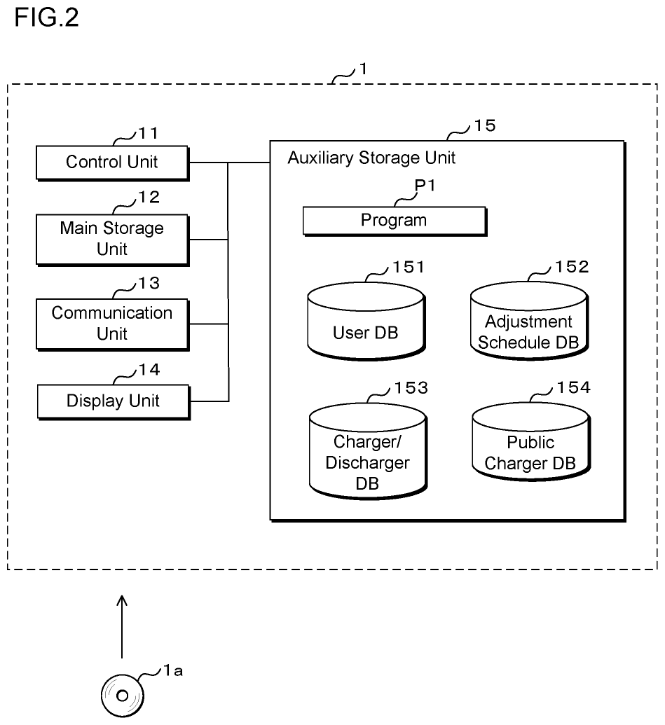

FIG. 2 is a block diagram illustrating an example of a configuration of the server 1. The server 1 includes a control unit 11, a main storage unit 12, a communication unit 13, a display unit 14, and an auxiliary storage unit 15.

The control unit 11 has one or more arithmetic processing units such as a central processing unit (CPU), a micro-processing unit (MPU), and a graphics processing unit (GPU), reads a program P1 stored in the auxiliary storage unit 15, and executes the program P1 to perform various types of information processing, control processing, and the like. The main storage unit 12 is a temporary storage area such as a static random access memory (SRAM), a dynamic random access memory (DRAM), or a flash memory, and temporarily stores data necessary for the control unit 11 to perform arithmetic processing. The communication unit 13 is a communication module for performing a process related to communication, and transmits and receives information to and from the outside. The display unit 14 is a display screen of a liquid crystal display or the like and displays images.

The auxiliary storage unit 15 is a non-volatile storage area, such as a large-capacity memory or a hard disk, and stores the program P1 necessary for the control unit 11 to perform a process and other data. In addition, the auxiliary storage unit 15 stores a user DB 151, an adjustment schedule DB 152, a charger/discharger DB 153, and a public charger DB 154. The user DB 151 is a database that stores information of each user. The adjustment schedule DB 152 is a database that stores a power supply and demand adjustment schedule. The charger/discharger DB 153 is a database that stores information of each charger/discharger 3. The public charger DB 154 is a database that stores information of each public charger 4.

Further, the auxiliary storage unit 15 may be an external storage device connected to the server 1. Furthermore, the server 1 may be a multi-computer that is composed of a plurality of computers or may be a virtual machine that is virtually constructed by software.

In addition, the server 1 may include a reading unit that reads a non-transitory computer-readable recording medium 1a and may read the program P1 (program product) from the recording medium 1a. Further, the program P1 may be executed on a single computer or may be executed on a plurality of computers that are connected to each other through a network N.

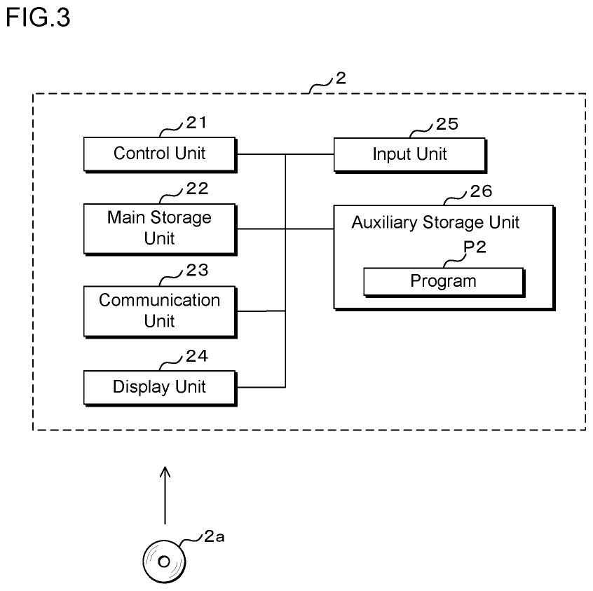

FIG. 3 is a block diagram illustrating an example of a configuration of the terminal 2. The terminal 2 includes a control unit 21, a main storage unit 22, a communication unit 23, a display unit 24, an input unit 25, and an auxiliary storage unit 26.

The control unit 21 has one or more processors, such as a CPU, reads a program P2 stored in the auxiliary storage unit 26, and executes the program P2 to perform various types of information processing. The main storage unit 22 is a temporary storage area, such as a RAM, and temporarily stores data necessary for the control unit 21 to perform arithmetic processing. The communication unit 23 is a communication module for performing a process related to communication, and transmits and receives information to and from the outside. The display unit 24 is a display screen of a liquid crystal display or the like and displays images. The input unit 25 is an operation interface, such as a keyboard or a mouse, and receives an operation input from the user. The auxiliary storage unit 26 is a non-volatile storage area, such as a hard disk or a large-capacity memory, and stores the program P2 necessary for the control unit 21 to perform a process and other data.

In addition, the terminal 2 may include a reading unit that reads a non-transitory computer-readable recording medium 2a and may read the program P2 (program product) from the recording medium 2a. Furthermore, the program P2 may be executed on a single computer or may be executed on a plurality of computers that are connected to each other through the network N.

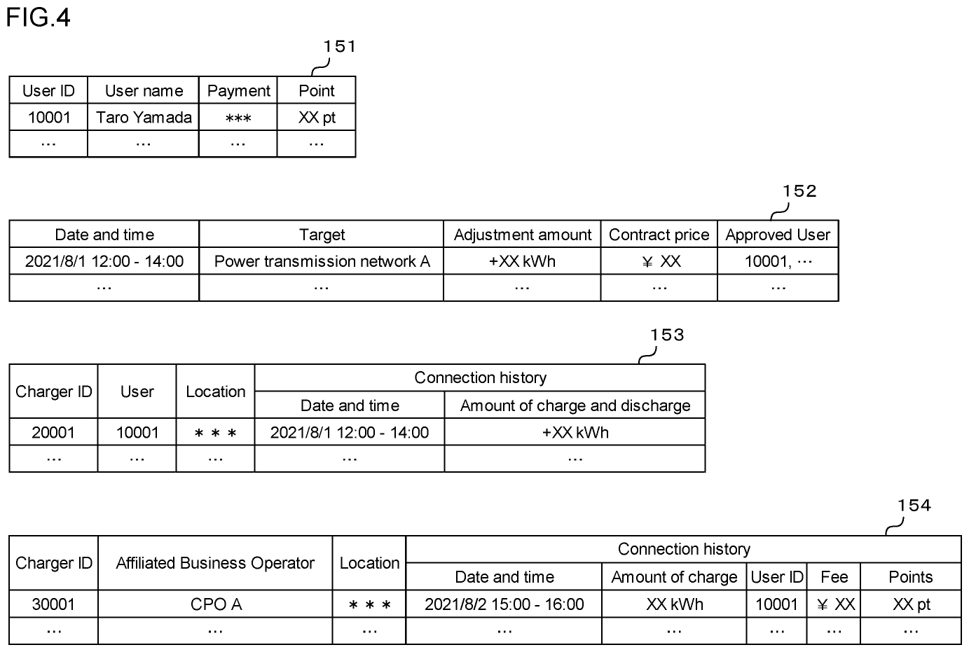

FIG. 4 is a diagram illustrating an example of a record layout of the user DB 151, the adjustment schedule DB 152, the charger/discharger DB 153, and the public charger DB 154.

The user DB 151 includes a user ID column, a user name column, a payment column, and a point column. The user ID column stores a user ID which is an identifier of each user. The user name column, the payment column, and the point column are associated with the user ID and store a user name, payment information (for example, credit card information) that is referred to when settlement with the user is performed, and the number of points currently held by the user, respectively.

The adjustment schedule DB 152 includes a date and time column, a target column, an adjustment amount column, a contract price column, and an approved user column. The date and time column stores an adjustment time period during which power supply and demand adjustment is scheduled. The adjustment time period stored in the adjustment schedule DB 152 is a time period designated by a power supply and demand adjustment request from the general power transmission and distribution business operator or the like and is, for example, an adjustment time period agreed upon in power sales transactions contracted with the general power transmission and distribution business operator or the like through a predetermined power market (a supply and demand adjustment market or the like). The target column, the adjustment amount column, the contract price column, and the approved user column are associated with the adjustment time period and store the range of the power transmission and distribution network S to be adjusted, the amount of adjustment of power supply and demand, a contract price, and the user ID of the user who has approved an electric vehicle connection request for supply and demand adjustment, respectively. In addition, for positive and negative signs of the amount of adjustment, the positive (plus) sign indicates the supply of power from the customer (charger/discharger 3) managed by the aggregator, that is, power selling, and the negative (minus) sign indicates the creation of power demand, that is, power purchase.

The charger/discharger DB 153 includes a charger ID column, a user column, a location column, and a connection history column. The charger ID column stores a charger/discharger ID which is an identifier of each charger/discharger 3. The user column, the location column, and the connection history column are associated with the charger/discharger ID and store the user ID of the user (owner or lessee) of the charger/discharger 3, the installation location of the charger/discharger 3, and the connection history of the charger/discharger 3 (a connection date and time and the amount of charge and discharge), respectively. In addition, positive and negative signs of the amount of charge and discharge indicate charging or discharging (for example, the positive sign indicates discharging, and the negative sign indicates charging).

The public charger DB 154 includes a charger ID column, an affiliated business operator column, a location column, and a connection history column. The charger ID column stores a charger ID which is an identifier of each public charger 4. The affiliated business operator column, the location column, and the connection history column are associated with the charger ID and store an affiliated business operator (CPO or the like) that manages the public charger 4, the installation location of the public charger 4, and the connection history of the electric vehicle of the user of this system to the public charger 4 (for example, a connection date and time, the amount of charge, a user ID, a charging fee, and the number of points used at the time of charging), respectively.

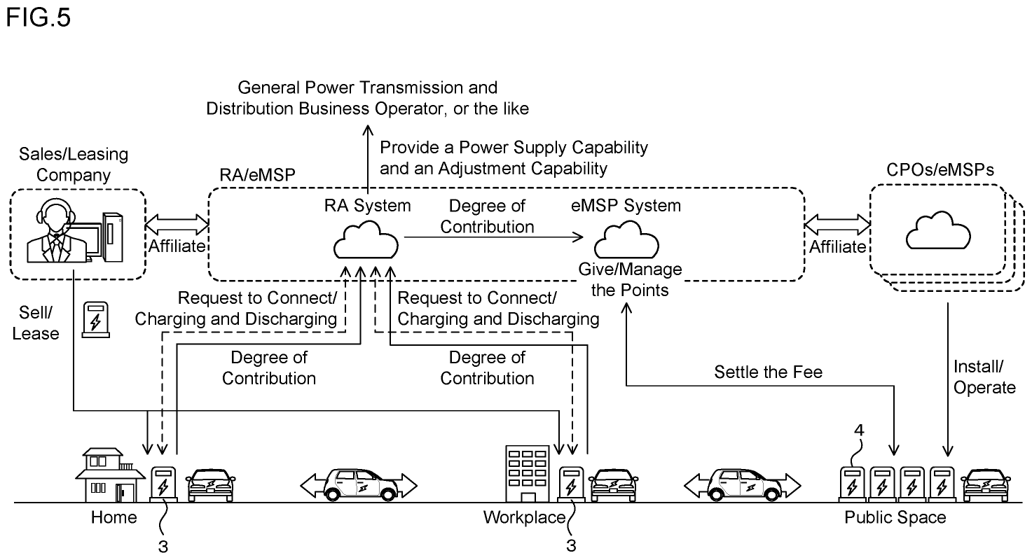

FIG. 5 is a diagram illustrating an outline of Embodiment 1. FIG. 5 illustrates an aspect in which a benefit is given to the user according to the degree of contribution of the user to the aggregator and the user uses the points to perform charging at the public charger 4. An outline of this embodiment will be described with reference to FIG. 5.

First, the giving of the benefit to the user will be described. As described above, the server 1 functions as the aggregator (“RA” in FIG. 5) that controls energy resources of a plurality of customers. The charger/discharger 3 that can charge an electric vehicle and perform discharging (power supply) from the electric vehicle to the power transmission and distribution network S is installed in some or all of the customer facilities managed by the aggregator.

For example, the charger/discharger 3 is installed at the home, workplace, or the like of the user of the electric vehicle. The charger/discharger 3 is provided (sold or leased) to the user by a predetermined sales company and/or a predetermined leasing company, and the user uses the charger/discharger 3 to charge the electric vehicle. Further, in this embodiment, the sales company and/or the leasing company of the target charger/discharger 3 is also affiliated with the operator of this system.

In addition, it is preferable that the server 1 not only gives a benefit according to the connection status (the degree of contribution) of the electric vehicle to the charger/discharger 3, but also gives a benefit when the user of the electric vehicle introduces (purchases or leases) the charger/discharger 3 which will be described below. Specifically, when a user who is a member of this system newly introduces the charger/discharger 3, the server 1 acquires introduction information indicating that the charger/discharger 3 has been introduced from the sales company and/or the leasing company of the charger/discharger 3. The introduction information includes a user ID, which is an identifier of the user who has introduced the charger/discharger 3, and information (product name and the like) of the introduced charger/discharger 3. In a case where the introduction information is acquired, the server 1 gives a predetermined number of points to the user. For example, the server 1 gives the number of points proportional to the purchase price or lease price of the charger/discharger 3.

Further, the server 1 may change the number of points given, depending on whether or not the charger/discharger 3 is a quick charger, in addition to the purchase price or the lease price. For example, the server 1 gives more points in a case where the charger/discharger 3 is a quick charger. Alternatively, the server 1 may give points only in a case where the charger/discharger 3 is a quick charger. In this case, the spread of the quick charger is promoted, and it is possible to quickly perform the supply (discharge) of power to the power transmission and distribution network S and the creation (charge) of demand at the time of adjusting power supply and demand which will be described below.

Each charger/discharger 3 is connected to the server 1 such that it can communicate with the server 1. The server 1 acquires the connection information indicating the connection status of the electric vehicle (the presence or absence of the connection, the amount of charge and discharge, and the like) from each charger/discharger 3. The server 1 stores the acquired connection information as a connection history in the charger/discharger DB 153 in association with the charger ID and the user ID.

The server 1 gives points to the user according to the connection status of the electric vehicle to the charger/discharger 3. The points are points that can be used for charging at the affiliated public charger 4 and that can be exchanged for a charging fee at the public charger 4. The server 1 defines the price of points per unit quantity. In a case where the user uses the public charger 4, the charging fee and the points are exchanged.

In addition, in this embodiment, the configuration in which the points are used for the charging fee has been described. However, this embodiment is not limited thereto. For example, the points of this system may be integrated with other point programs (retail store chain point cards and the like) such that the points can be used for the purchase of products and the like.

Further, in this embodiment, the configuration in which the points are given as the benefit to the user has been described. However, this embodiment is not limited thereto. For example, the server 1 may give a membership grade indicating the grade of membership to the user who is a member of this system. The membership grade is, for example, the right to perform free charging at the public charger 4 for a predetermined period of time. For example, in a case where the server 1 specifies the degree of contribution to the aggregator and gives a benefit as described below, the server 1 gives membership grades, such as “Platinum”, “Gold”, and “Silver”, according to the magnitude of the degree of contribution. The server 1 sets the length of a free period according to the membership grade and allows free charging at the public charger 4 during the free period. As described above, the benefit given to the user is not limited to electronic points. Furthermore, the server 1 may change the grade of the benefit separately from the degree of contribution to the aggregator. For example, the server 1 gives a high membership grade to a user who has purchased the charger/discharger 3 in a lump sum or a user who has made a long-term (for example, 5-year lease) lease contract. On the other hand, the server 1 gives a low membership grade to a user who has purchased the charger/discharger 3 in installments (for example, a 5-year loan) or a user who has made a short-term lease contract (for example, a 2-year lease). The server 1 stores the grade in the user DB 151 in association with the user ID. In a case where the electric vehicle of the user is charged by the public charger 4, the server 1 allows charging under different conditions according to the grade, with reference to the user DB 151. In addition, other benefits can be given even when there is no contribution to the aggregator. For example, the server 1 may give a second benefit to the user who has purchased or leased the charger/discharger 3. In this case, the server 1 stores the second benefit in the user DB 151 in association with the user ID. In a case where the electric vehicle of the user having the second benefit is charged by the public chargers 4 that are dispersively disposed, the server 1 allows charging for free or at a lower cost than that for the user who does not have the second benefit or who does not have any benefit, with reference to the user DB 151. Further, the server 1 may set the grade according to purchase or lease conditions. For example, the server 1 gives a high membership grade to a user who has purchased the charger/discharger 3 in a lump sum or a user who has made a long-term (for example, 5-year lease) lease contract. On the other hand, the server 1 gives a low membership grade to a user who has purchased the charger/discharger 3 in installments (for example, a 5-year loan) or a user who has made a short-term lease contract (for example, a 2-year lease). The server 1 stores the second benefit and the grade in the user DB 151 in association with the user ID. In a case where the electric vehicle of the user having the second benefit is charged by the public charger 4, the server 1 allows charging under different conditions according to the grade with reference to the user DB 151. Furthermore, in this embodiment, an example of an individual user has been described. However, the same applies to a corporate user who owns a plurality of electric vehicles. In this case, the benefit or the second benefit is given to a predetermined number of employee users belonging to the corporation. Moreover, the electric vehicle may be a self-driving vehicle and may be charged and discharged by the charger/discharger 3 according to a pre programmed schedule.

As described above, the server 1 gives points according to the connection status of the electric vehicle to the charger/discharger 3. In this case, the server 1 specifies the degree of contribution of the user to the aggregator according to the connection status of the electric vehicle. The server 1 gives points to the user on the basis of the specified degree of contribution.

Specifically, the server 1 specifies, as the degree of contribution, the parallel waiting time of the electric vehicle for the charger/discharger 3, the number of parallel waiting operations, the number of times the electric vehicle is charged and discharged by the charger/discharger 3, a charge and discharge time, charge and discharge power (kW), and/or the amount of charge and discharge power (kWh) per unit period (week, month, or the like) or during a designated time period. In addition, the “parallel waiting” means a state in which the electric vehicle is connected to the charger/discharger 3 (a state in which charging and discharging are possible), regardless of whether charging or discharging is performed. The designated time period means a time period designated by the operator of this system, that is, the aggregator. In this embodiment, the designated time period means a power supply and demand adjustment time period agreed (contracted) with the general power transmission and distribution business operator or the like as described below.

The server 1 specifies the degree of contribution on the basis of at least one data item among the parallel waiting time, the number of parallel waiting operations, the number of times the electric vehicle is charged and discharged, the charge and discharge time, the charge and discharge power, and the amount of charge and discharge power. In addition, these are examples of criteria for the degree of contribution, and other data may be used as the criteria.

The server 1 gives points in such a way that, as the degree of contribution is larger, a larger number of points are given. For example, the server 1 gives the number of points proportional to the degree of contribution. Alternatively, the server 1 may give the number of points proportional to the power of the degree of contribution.

In this embodiment, for example, the parallel waiting time of the electric vehicle during the designated time period designated by the aggregator is specified as the degree of contribution, and points are given according to the parallel waiting time. For example, the server 1 receives a power supply and demand adjustment request from the general power transmission and distribution business operator, the retailer, or the like and sets the power supply and demand adjustment time period designated by the general power transmission and distribution business operator or the like as the designated time period.

For example, the operator of this system, that is, the aggregator conducts sales transactions related to power supply and demand with the general power transmission and distribution business operator or the like through a predetermined power market (a wholesale power market, a supply and demand adjustment market, a capacity market, or the like). The server 1 stores information of the transactions contracted with the general power transmission and distribution business operator or the like as the adjustment request in the adjustment schedule DB 152. The information stored in the adjustment schedule DB 152 includes, for example, information such as the power supply and demand adjustment time period, the amount of adjustment (the amount of power), and the contract price. In this system, revenue from the transactions with the general power transmission and distribution business operator or the like is the source of the points.

In addition, the adjustment request may be received directly from the general power transmission and distribution business operator or the like without passing through the power market.

The server 1 requests each user to connect the electric vehicle to the charger/discharger 3 according to the adjustment request stored in the adjustment schedule DB 152. Specifically, the server 1 delivers a connection request to the terminal 2 of each user such that the electric vehicle is connected during the adjustment time period contracted with the general power transmission and distribution business operator or the like. In response to the connection request from the server 1, the terminal 2 receives, from the user, the input of an operation of determining whether or not to approve the connection request, that is, whether or not to cooperate with supply and demand adjustment. The server 1 receives the approval of the connection request from the user and gives points to the user in a case where the electric vehicle of the user is connected to the charger/discharger 3 during the adjustment time period.

FIG. 6 is a diagram illustrating an example of a display screen of the terminal 2. FIG. 6 illustrates the display screen for the connection request delivered from the server 1.

The terminal 2 displays a screen including holding points 61 and demands 62, 62, 62, . . . . The holding points 61 are the number of points currently held by the user. The demands 62, 62, 62, . . . are display columns indicating the electric vehicle connection requests delivered from the server 1. The terminal 2 displays a list of one or more connection requests delivered from the server 1 as the demand 62.

For example, as illustrated in FIG. 6, the terminal 2 displays, in the demand 62, the designated time period (adjustment time period) during which the electric vehicle should be connected and the number of points (the number of points given per unit time) that are given in a case where the electric vehicle is connected during the designated time period. In addition, the number of points given which is displayed in the demand 62 is determined, for example, according to the transaction price of power contracted with the general power transmission and distribution business operator or the like. The terminal 2 displays an accept button 621 in the demand 62. In response to the operation input to the accept button 621, the terminal 2 receives the approval of the connection request from the user.

Further, in a case where the approval of the connection request is received from each user, the server 1 may change the number of points to be given depending on the order in which the approvals are received. For example, the server 1 gives more points to a predetermined number of users who are ranked higher in the approval order than to the users who are ranked lower. For example, as illustrated in FIG. 6, in a case where the total number of users currently approved the connection request is less than a fixed number of users (a predetermined number of users), the terminal 2 displays the number of points added in the demand 62. This makes it possible to guide the users such that the approval can be quickly received from a large number of users.

Returning to FIG. 5, the description will continue. In a case where the designated time period comes, the server 1 determines whether or not the electric vehicle of each user who has approved the connection request is connected to the charger/discharger 3. Then, the server 1 gives points to the user according to the time for which the electric vehicle is connected to the charger/discharger 3, that is, the parallel waiting time in the designated time period.

Further, in this case, the server 1 may specify the degree of contribution of the user in consideration of factors other than the parallel waiting time and give points. For example, in a case where the electric vehicle is disconnected during the designated time period, the server 1 may reduce the degree of contribution and decrease the number of points to be given. This makes it possible to guide the user such that the electric vehicle is not disconnected during the designated time period.

In addition, the server 1 may specify the degree of contribution according to the remaining power level (remaining battery level) of the electric vehicle at the time of connection to the charger/discharger 3. For example, in a case where a power supply (power generation) adjustment request is received from the general power transmission and distribution business operator or the like, the server 1 increases the degree of contribution and gives more points as the remaining power level is higher. Further, in a case where a power consumption (demand creation) adjustment request is received, the server 1 increases the degree of contribution and gives more points as the remaining power level is lower. This makes it possible to guide the user so as to accurately contribute to the adjustment request.

Next, a process of performing the settlement of the charging fee at the public charger 4 using points will be described. For example, the operator (e mobility service provider) of this system issues a membership card (IC card) to each user. The membership card is a card on which a user ID, which is an identifier of the user, has been recorded. The public charger 4 reads the membership card using a reading means (not illustrated) and sends an inquiry to the server 1.

Further, in this embodiment, the operator of this system issues the membership card. However, the affiliated business operator that operates the public charger 4 may issue the membership card. In addition, the business operator issuing the membership card may be a third party that is different from the operator of this system or the affiliated business operator (for example, in a case where the points of this system are integrated with another point program, a business operator that operates the point program).

Furthermore, in this embodiment, the membership card is used to authenticate the user. However, for example, an application program installed in the terminal 2 may be provided with an authentication function (a function of transmitting and receiving an ID to and from the public charger 4), and the public charger 4 may communicate with the terminal 2 such that the points can be used.

The server 1 acquires the user ID read from the membership card and the charger ID, which is an identifier of the public charger 4, from the public charger 4. The server 1 authenticates the user on the basis of the user ID and returns an authentication result to the public charger 4. In addition, in a case where charging at the public charger 4 is ended, the server 1 acquires the amount of charge (charging fee) from the public charger 4.

The server 1 reads the number of points held by the user associated with the user ID from the user DB 151 and performs the process of settling a charging fee. That is, the server 1 subtracts the number of points held by the user according to the charging fee and stores the number of points after the subtraction in the user DB 151.

The server 1 stores information, such as the user ID of the user who used the public charger 4, the date and time of use (time period), the amount of charge, the charging fee, and the points used, as the charging history in the public charger DB 154 in association with the charger ID of the public charger 4. The operator (e-mobility service provider) of this system pays the charging fee, which has been subtracted using points, to the affiliated business operator.

Further, in a case where the number of points held by the user is less than a predetermined number of points, the server 1 may prohibit the use of points at the time of charging at the public charger 4. This enables the user to be encouraged to contribute to the aggregator.

As described above, according to this embodiment, since the benefit is given according to the degree of contribution to the aggregator, it is possible to improve the connection rate of the electric vehicle to the charger/discharger 3 and to improve the predictability of whether or not the electric vehicle is connected. In particular, in this embodiment, since the benefit can be used at the time of charging at the public charger 4, it is possible to reduce subscription fees to public charging services which are a burden to the users of the electric vehicles. In addition, in this embodiment, an example has been described in which the server 1 and the public charger 4 cooperate to perform settlement. However, the present invention is not limited thereto. For example, the CPO may specify the amount of charge of each user at the public charger 4 and transmit a bill corresponding to the specified amount of charge of each user to the server 1. Specifically, the operator of this system distributes cards that can be used in the CPO to the users. The user can use the card to charge the electric vehicle at the public charger 4 for free. The usage fee of the user is charged to the operator of this system by the CPO. This system receives the usage fee from the user and subtracts points. Further, the points are not subtracted during the free period, depending on the grade of the user.

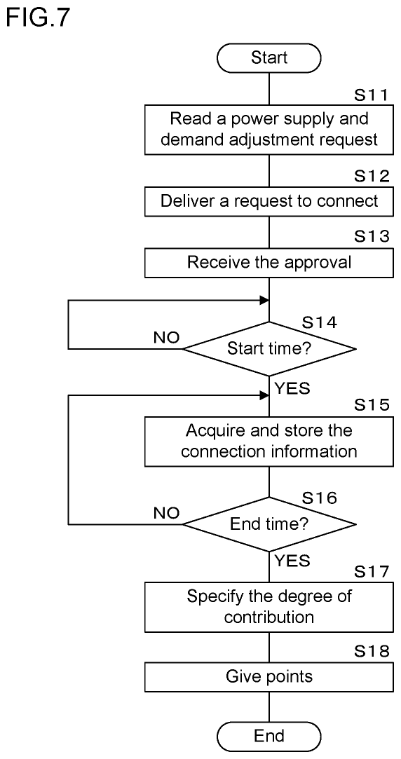

FIG. 7 is a flowchart illustrating a procedure of a point giving process. A flow of a process when points are given will be described with reference to FIG. 7.

The control unit 11 of the server 1 reads a power supply and demand adjustment request from the adjustment schedule DB 152 (step S11). The adjustment request is a power supply and demand adjustment request from the general power transmission and distribution business operator, the retailer, or the like and is, for example, information of the power sales transactions contracted with the general power transmission and distribution business operator or the like in the power market. The control unit 11 reads information (the power supply and demand adjustment time period, the amount of adjustment, and the like) related to the adjustment request from the adjustment schedule DB 152.

The control unit 11 delivers a request to connect the electric vehicle to the charger/discharger 3 to the terminal 2 of each user on the basis of the read information related to the adjustment request (step S12). The connection request includes, for example, the number of points given which corresponds to the designated time period (adjustment time period) during which the electric vehicle is connected to the charger/discharger 3 and the parallel waiting time. The control unit 11 receives the approval of the connection request from the terminal 2 of each user (step S13). The control unit 11 stores the identifier (user ID) of the user who has approved the connection request in the adjustment schedule DB 152.

The control unit 11 determines whether or not the start time of the designated time period has come (step S14). In a case where it is determined that the start time has not yet come (S14: NO), the control unit 11 waits for a process. In a case where it is determined that the start time has come (S14: YES), the control unit 11 sequentially acquires connection information indicating the connection status of the electric vehicle from the charger/discharger 3 corresponding to the user who has approved the connection request and stores the connection information in the charger/discharger DB 153 (step S15).

The control unit 11 determines whether or not the end time of the designated time period has come (step S16). In a case where it is determined that the end time has not yet come (S16: NO), the control unit 11 returns the process to step S15. In a case where it is determined that the end time has come (S16: YES), the control unit 11 specifies the degree of contribution of the user to the aggregator according to the connection status of the electric vehicle to the charger/discharger 3 (step S17). Specifically, the control unit 11 specifies the parallel waiting time as the degree of contribution. The control unit 11 gives points in association with the user according to the specified degree of contribution (step S18) and ends the series of processes.

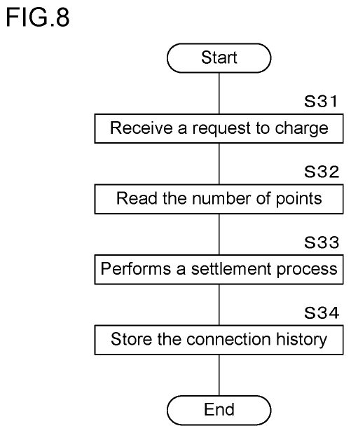

FIG. 8 is a flowchart illustrating a procedure of a point usage process. A flow of a process of performing the settlement of the charging fee at the public charger 4 using points will be described with reference to FIG. 8.

In a case where the electric vehicle is connected to the public charger 4, the control unit 11 of the server 1 receives a request to charge the electric vehicle (step S31). The charging request includes the identifier (user ID) of the user of the electric vehicle and the identifier (charger ID) of the public charger 4.

The control unit 11 reads the number of points held by the user corresponding to the user ID from the user DB 151 (step S32). In a case where charging has been completed, the control unit 11 performs a charging fee settlement process on the basis of the read number of points (step S33). That is, the server 1 subtracts the number of points held by the user according to the charging fee and stores the number of points after the subtraction in the user DB 151. The control unit 11 stores the connection history of the electric vehicle to the public charger 4 in the public charger DB 154 (step S34) and ends the series of processes.

In addition, in the above description, the owner of the charger/discharger 3 and the owner of the electric vehicle are the same person and a benefit is given to the owner (user) of the electric vehicle. However, this embodiment is limited thereto. For example, in a case where the owner of the charger/discharger 3 and the owner of the electric vehicle are different from each other, the server 1 may give the benefit to the owner of the charger/discharger 3. In this case, for example, the following case is assumed: a case where the company where the user works is the owner of the charger/discharger 3; or a case where the charger/discharger 3 is installed in a facility, such as a hotel, used by an unspecified number of users. In the above-described case, since the benefit is given to the owner of the charger/discharger 3, incentives to contribute to the aggregator can be given not only to the owner of the electric vehicle but also to a person or an organization that allows the owner of the electric vehicle to use the charger/discharger 3.

As described above, according to Embodiment 1, it is possible to suitably utilize an electric vehicle as a distributed power source.

### Embodiment 2

In Embodiment 1, an aspect has been described in which the points that can be used at the time of charging at the public charger 4 are given to the user according to the connection status to the charger/discharger 3. In this embodiment, an aspect will be described in which a connection trend of the electric vehicle to each charger is predicted on the basis of the connection history at each charger (the charger/discharger 3 and the public charger 4). In addition, content that overlaps with that in Embodiment 1 is denoted by the same reference numeral, and a description thereof will be omitted.

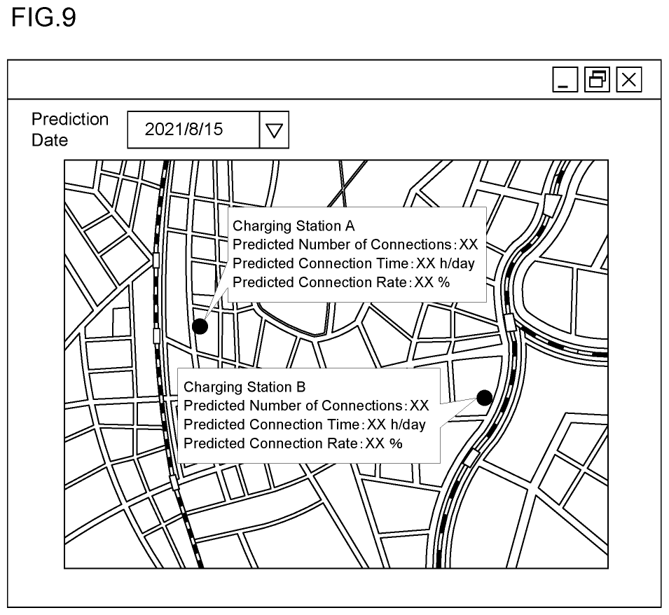

FIG. 9 is a diagram illustrating an outline of Embodiment 2. FIG. 9 illustrates an example of a screen on which a prediction result of predicting a future connection trend of the charger/discharger 3 and the public charger 4 is displayed. The outline of this embodiment will be described with reference to FIG. 9.

As described above, the server 1 gives points to the user according to the connection status to the charger/discharger 3 and performs the process of settling the charging fee using the points at the time of charging at the public charger 4. As a result, the connection histories to each charger are recorded on the charger/discharger DB 153 and the public charger DB 154. The server 1 predicts the future connection trend of each charger on the basis of the connection histories stored in each database.

Further, in this embodiment, the connection trend of both the charger/discharger 3 and the public charger 4 is predicted. However, the connection trend of only one of them may be predicted.

A specific method for predicting the connection trend is not particularly important. However, for example, the server 1 totals the number of times the electric vehicle is connected per unit period (for example, per day), a connection time, a connection rate (a value obtained by dividing the connection time by the unit period), and the like for each charger and for each period such as by days of the week or by season. The server 1 predicts the number of connections, the connection time, the connection rate, and the like at a certain date and time (date) in the future as the connection trend on the basis of the total result. In addition, the server 1 may predict the next connection date and time of the electric vehicle or the number of connections in the unit period (for example, the next week) on the basis of the connection history of the electric vehicle. In this case, the server 1 stores the histories of a connection start date and time, a connection end date and time, a connection target device, the amount of charge, the amount of discharge, the remaining battery level, and the like obtained from the electric vehicle when the electric vehicle is connected to the charger/discharger 3, the public charger 4, or the like in the user DB 151 in association with the user ID. The server 1 predicts the next connection date and time or the number of connections of the electric vehicle on the basis of the histories accumulated in time series. Specifically, in a case where the histories obtained in time series are input, the server 1 performs the prediction using a machine learning model that predicts the future connection date and time or the number of connections per unit week. This prediction can be performed on many electric vehicles to be utilized for various power supply services including demand prediction, a plan to install the public charger 4, and the like. In addition, the server 1 may predict a predicted charge time period and a predicted discharge time period in a specific day of the week on the basis of the history of the charge time period and the discharge time period of the user at the charger/discharger 3. Similarly, the server 1 may estimate a predicted charge frequency and a predicted discharge frequency in a specific month or week on the basis of the history of the charge frequency and the discharge frequency of the user at the charger/discharger 3. In addition, the server 1 may predict a predicted charge time period in a specific day of the week on the basis of the history of the charge time period of the user at the public charger 4. Further, the server 1 may predict a predicted charge time period in a specific day of the week on the basis of the history of the charge time period of the user at the public charger 4. Furthermore, the server 1 may predict the connection rate of the charger/discharger 3 to which the electric vehicle is connected and which contributes to discharge, using machine learning. In this case, a learning model is trained with reference to a weather history, the adjustment schedule DB 152, and the charger/discharger DB 153 such that it receives the amount of adjustment, weather, a day of the week, or a time period as an input and outputs the connection rate of the electric vehicle that performs discharge. The connection rate is, for example, a value obtained by dividing the number of chargers/dischargers 3, to which the electric vehicles that perform discharging are connected, by the total number of chargers/dischargers 3 present in a predicted area and multiplying the result by 100. In addition, for example, deep learning, long-short term memory (LSTM), a transformer, a decision tree, a support vector machine (SVM), or the like may be used as the learning model. Therefore, the server 1 can obtain the predicted connection rate by inputting weather, a day of the week, or a time period to the learning model in addition to the amount of adjustment required for a target area.

In addition, for example, the server 1 may predict the connection trend to the charger to be predicted with reference to both the connection history of the individual charger and the connection history of other chargers installed around the charger to be predicted. For example, the server 1 predicts the connection trend with reference to the connection histories of chargers located within a predetermined geographical range from the charger to be predicted. This makes it possible to more suitably predict the connection trend of each charger.

The server 1 displays the prediction results of the connection trend on the display unit 14. For example, as illustrated in FIG. 9, the server 1 displays a map image showing the position of each charger and also displays the number of connections, the connection time, the connection rate, and the like in association with each charger.

For example, the server 1 provides the prediction results of the connection trend illustrated in FIG. 9 to each user who uses the charger and the affiliated business operator that manages the public charger 4. In addition, the prediction results may be provided to a third party other than the user and the affiliated business operator. The server 1 outputs the prediction results to the user and the affiliated business operator such that the user and the affiliated business operator can view the screen illustrated in FIG. 9 and the like.

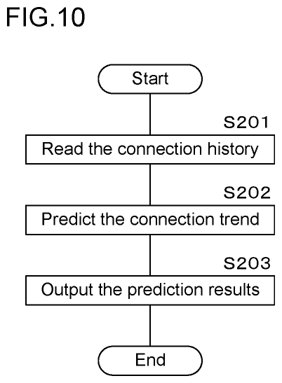

FIG. 10 is a flowchart illustrating a procedure of a connection trend prediction process. The procedure of the process performed by the server 1 according to this embodiment will be described with reference to FIG. 10.

The control unit 11 of the server 1 reads the connection history of each charger/discharger 3 and/or each public charger 4 from the charger/discharger DB 153 and/or the public charger DB 154 (step S201). The connection history of the charger/discharger 3 includes the date and time (time period) when the electric vehicle of the user of this system was connected to the charger/discharger 3, the amount of charge and discharge, and the like. The connection history of the public charger 4 includes the time period during which the electric vehicle of the user of this system was connected to the public charger 4, the amount of charge, and the like.

The control unit 11 predicts the connection trend of the electric vehicle to the charger/discharger 3 and/or the public charger 4 on the basis of the connection history of the charger/discharger 3 and/or the public charger 4 (step S202). For example, the control unit 11 predicts the number of connections, the connection time, the connection rate, and the like of each charger/discharger 3 and/or each public charger 4 at a certain date and time in the future. The control unit 11 outputs the prediction results to the user, the affiliated business operator, and the like (step S203) and ends the series of processes.

In addition, the aspect in which the connection trend to each public charger 4 is predicted from the connection history has been described above. However, the number of points required to settle the charging fee at each public charger 4 may be changed depending on the connection history to each public charger 4. For example, the server 1 lowers an exchange price per point at the time of settling the charging fee as the values of the number of connections, the connection time, the connection rate, and the like are larger. Alternatively, in a case where the values of the number of connections, the connection time, the connection rate, and the like are equal to or greater than a predetermined value, the server 1 may prohibit the settlement using points. As described above, as the frequency of connection of the electric vehicle to the public charger 4 (the number of connections, the connection time, the connection rate, and the like per unit period) is higher, the required number of points is larger or the use of the points is prohibited, which makes it possible to suppress the concentration of usage on some public chargers 4.

As described above, according to Embodiment 2, it is possible to further improve the predictability of whether or not the electric vehicle is connected to each charger. The following supplementary notes are disclosed.

### (Supplementary Note 1)

An information processing method executed by a computer, the information processing method including a process of:
acquiring information indicating a connection status of an electric vehicle to a charger/discharger managed by an aggregator;
specifying a degree of contribution to the aggregator by the electric vehicle according to the connection status; and
giving a benefit in association with a user of the electric vehicle according to the specified degree of contribution.

### (Supplementary Note 2)

The information processing method according to Supplementary Note 1,
in which a second benefit is given to a user who has purchased or leased the charger/discharger.

### (Supplementary Note 3)

The information processing method according to Supplementary Note 2,
in which an electric vehicle of the user who has the second benefit is charged by a public charger that is dispersively disposed for free or at a lower cost than that of a user who does not have the benefit or the second benefit.

It is to be noted that, as used herein and in the appended claims, the singular forms “a”, “an”, and “the” include plural referents unless the context clearly dictates otherwise.

It is to be noted that the disclosed embodiment is illustrative and not restrictive in all aspects. The scope of the present invention is defined by the appended claims rather than by the description preceding them, and all changes that fall within metes and bounds of the claims, or equivalence of such metes and bounds thereof are therefore intended to be embraced by the claims.

1-13. (canceled)

14. An information processing method for causing a computer to execute processing of:
acquiring information indicating a connection status of an electric vehicle to a charger/discharger managed by an aggregator;
specifying a degree of contribution to the aggregator by the electric vehicle according to the connection status; and
giving a benefit in association with a user of the electric vehicle according to the specified degree of contribution.

15. The information processing method according to claim 14, further causing a computer to execute processing of specifying the degree of contribution on the basis of a parallel waiting time of the electric vehicle for the charger/discharger, the number of parallel waiting operations, the number of times the electric vehicle is charged and discharged through the charger/discharger, a charge and discharge time, charge and discharge power, or an amount of charge and discharge power.

16. The information processing method according to claim 14, further causing a computer to execute processing of specifying the degree of contribution on the basis of the parallel waiting time of the electric vehicle in a designated time period designated by the aggregator.

17. The information processing method according to claim 14, further causing a computer to execute processing of:
acquiring a request to adjust power supply and demand in a power transmission and distribution network to which the charger/discharger is connected, and
specifying the degree of contribution on the basis of the parallel waiting time of the electric vehicle in an adjustment time period designated in the adjustment request.

18. The information processing method according to claim 14, further causing a computer to execute processing of giving a benefit capable of being used to settle a charging fee at a public charger that is dispersively disposed according to the degree of contribution.

19. The information processing method according to claim 18, further causing a computer to execute processing of giving points capable of being exchanged for the charging fee at the public charger are given as a benefit.

20. The information processing method according to claim 18, further causing a computer to execute processing of giving a free period during which charging is capable of being performed for free at the public charger as a benefit.

21. The information processing method according to claim 18, further causing a computer to execute processing of:
reading a benefit corresponding to the user from a storage unit when the user uses the public charger, and
performing a process of settling the charging fee according to the read benefit.

22. The information processing method according to claim 14, further causing a computer to execute processing of:
acquiring an identifier of the charger/discharger or a public charger and an identifier of the user or the electric vehicle when the electric vehicle is connected to the charger/discharger or the public charger, and
storing the identifier of the charger/discharger or the public charger, the identifier of the electric vehicle or the user, and a connection date and time of the electric vehicle in a storage unit in association with one another.

23. The information processing method according to claim 22, further causing a computer to execute processing of predicting a connection trend of the electric vehicle to each charger/discharger or each public charger on the basis of a connection history of each charger/discharger or each public charger stored in the storage unit.

24. The information processing method according to claim 14, further causing a computer to execute processing of:
acquiring introduction information indicating that the user has newly introduced the charger/discharger, and
giving a benefit in association with the user in a case where the introduction information is acquired.

25. An information processing device comprising:
at least one memory; and
at least one processor configured to execute instructions stored in the memory to:
acquire information indicating a connection status of an electric vehicle to a charger/discharger managed by an aggregator;
specify a degree of contribution to the aggregator by the electric vehicle according to the connection status; and
give a benefit in association with a user of the electric vehicle according to the specified degree of contribution.

26. A non-transitory computer-readable storage medium storing a program causing a computer to perform a process of:
acquiring a request to connect an electric vehicle to a charger/discharger managed by an aggregator, the connection request including a designated time period designated by the aggregator;
displaying the designated time period and an amount of benefit to be given in a case where the electric vehicle is connected to the charger/discharger during the designated time period on a display unit; and
receiving an input of an operation of determining whether or not to approve the connection request from a user.
